(19) United States
(12) Patent Application Publication
(10) Pub. No.: US 2024/0164446 A1
(43) Pub. Date: May 23, 2024

(54) CARTRIDGE AND NONCOMBUSTION-TYPE FLAVOR INHALER

(71) Applicant: JAPAN TOBACCO INC., Tokyo (JP)

(72) Inventors: Hirofumi MATSUMOTO, Tokyo (JP); Yuto WATANABE, Tokyo (JP); Ryuji SAITO, Tokyo (JP)

(73) Assignee: JAPAN TOBACCO INC., Tokyo (JP)

(21) Appl. No.: 18/424,118

(22) Filed: Jan. 26, 2024

Related U.S. Application Data
(63) Continuation of application No. PCT/JP2021/028194, filed on Jul. 29, 2021.

(51) Int. Cl. A24F 40/42; A24F 40/10; A24F 40/30; A24F 40/46; A24F 40/57

(52) U.S. Cl. CPC A24F 40/42; A24F 40/10; A24F 40/30; A24F 40/46; A24F 40/57

(57) ABSTRACT

A cartridge can be attached/detached to/from a body part of a noncombustion-type flavor inhaler including an antenna that emits microwaves for heating an aerosol source. The cartridge includes a reserving element that can hold the aerosol source and has an antenna accommodating part that can insertably/extractably accommodate the antenna when attaching/detaching the cartridge to/from the body part; and a reservoir that stores the aerosol source for supplying aerosol to the reserving element and is in liquid communication with a first reserving element end part that is located on the antenna insertion side of the reserving element.

### TECHNICAL FIELD

The present invention relates to a cartridge and a noncombustion-type flavor inhaler.

### BACKGROUND ART

Hitherto, an electronic cigarette in which, by using microwaves, a liquid for the electronic cigarette is heated and atomized has been proposed (see, for example, Patent Literature 1).

### CITATION LIST

### Patent Literature

PTL 1: Chinese Unexamined Patent Application Publication No. 110279152

### SUMMARY OF INVENTION

### Technical Problem

An object of the present invention is to enhance the performance of a noncombustion-type flavor inhaler that generates, by dielectric heating, aerosols for being inhaled by a user.

### Solution to Problem

A cartridge according to the present invention is attachable/detachable to/from a body part of a noncombustion-type flavor inhaler including an antenna that emits microwaves for heating an aerosol source. The cartridge includes a reserving element that is capable of holding the aerosol source and that has an antenna accommodating part that is capable of insertably/extractably accommodating the antenna when attaching/detaching the cartridge to/from the body part; and a reservoir that stores the aerosol source for being supplied to the reserving element and that is in liquid communication with a first reserving element end part that is located on an antenna insertion side of the reserving element, the antenna insertion side of the reserving element being a side toward which the antenna is inserted.

The antenna inserted into the antenna accommodating part of the reserving element emits microwaves to and heats the aerosol source held by the reserving element. Since the reservoir is one that causes the aerosol source to be in liquid communication with the first reserving element end part of the reserving element that is located on the antenna insertion side of the reserving element, the reservoir can be disposed closer to the antenna insertion side than the reserving element. That is, since the reservoir can be disposed so as to be situated away from a region to which microwaves are emitted, it is possible to suppress the aerosol source stored by the reservoir from absorbing the microwaves and from being heated, and thus reduce energy loss. Therefore, it is possible to enhance the performance of the noncombustion-type flavor inhaler. Note that the reservoir may be one that extends along a direction of insertion/extraction of the antenna into/from the antenna accommodating part.

The reservoir may be disposed in series with the reserving element along a direction of insertion of the antenna into the antenna accommodating part. Of the reservoir, a first reservoir end part that is located on a side toward which the antenna is extracted from the antenna accommodating part may be disposed closer to an antenna insertion side than an insertion end of the antenna in an inserted state with respect to the antenna accommodating part. This makes it possible to dispose the reservoir so as to be situated away from a region to which microwaves are emitted.

The cartridge may further include a reserving element accommodating member that accommodates the reserving element such that a chamber is formed around the reserving element, the chamber being provided to allow air taken in from outside to circulate therein and being provided for mixing the air and the aerosol source vaporized or atomized by microwaves emitted from the antenna. By providing such a chamber above, it is possible to cause aerosols that have been generated to circulate and to suppress re-coagulation of the aerosols.

The reserving element may have a pillar shape, and the chamber may include a first chamber region that faces a side peripheral portion of the reserving element and a second chamber region that faces the first reserving element end part that is located on the antenna insertion side of the reserving element. That is, “around the reserving element” above may include the first chamber region and the second chamber region. In discharging generated aerosols from an exposed surface of the reserving element exposed to the chamber, when the first chamber region and the second chamber region are provided, it is possible to expose the surface of the reserving element in a wider manner to the chamber and to increase the efficiency of generating aerosols by suppressing re-coagulation of the aerosols.

The reserving element accommodating member may include a partition wall that serves as a partition between the reservoir and the first reserving element end part, and an aerosol source supply path for supplying the aerosol source stored in the reservoir to the first reserving element end part may be formed in the partition wall. The reservoir may include a storage tank part that has a double tubular structure in which a transverse section orthogonal to a direction of insertion/extraction of the antenna has a ring shape, and an aerosol flow path that is formed on an inner side of an inner tube of the storage tank part so as to be separated from the storage tank part by the inner tube, and that is in air communication with an inhalation port of the noncombustion-type flavor inhaler, wherein an air-flow path for circulating aerosol in the aerosol flow path may be formed in the partition wall, the aerosol being generated in the chamber. The reserving element accommodating member may include a holding wall that is disposed to face the partition wall, and the reserving element may be held between the partition wall and the holding wall.

A noncombustion-type flavor inhaler according to the present invention includes the cartridge above, the body part to which/from which the cartridge is attachable/detachable, and the antenna above.

Note that contents given in the “Solution to Problem” section can be combined to the extent possible within a scope not departing from the problems and the technical ideas of the present invention.

### Advantageous Effects of Invention

According to the present invention, it is possible to increase the heating efficiency of the noncombustion-type flavor inhaler that uses dielectric heating.

### BRIEF DESCRIPTION OF DRAWINGS

FIG. 1 is a schematic view of an example of a structure of a noncombustion-type flavor inhaler according to an embodiment.

FIG. 2 is an exploded perspective view schematically showing a structure of a part of a body part and a cartridge.

FIG. 3 is an exploded perspective view schematically showing a structure of a part of the body part and the cartridge.

FIG. 4 is a longitudinal sectional view schematically showing a part of the body part and the cartridge in a detached state.

FIG. 5 is a longitudinal sectional view schematically showing a part of the body part and the cartridge in an attached state.

FIG. 6 is a sectional view of a part of the body part and the cartridge along a cutting-plane line A-A in FIG. 5.

FIG. 7 is a sectional view of a part of the body part and the cartridge along a cutting-plane line C-C in FIG. 6.

FIG. 8 is a perspective sectional view of a part of the body part and the cartridge along a cutting-plane line D-D in FIG. 6.

FIG. 9 illustrates a modification of a reserving element.

FIG. 10 illustrates another modification of a reserving element.

FIG. 11 illustrates an example of a cartridge including an antenna cover.

FIG. 12 illustrates an example in which the body part is provided with an antenna cover.

### DESCRIPTION OF EMBODIMENTS

An embodiment of a noncombustion-type flavor inhaler according to the present invention is described based on the drawings. For example, the dimensions, the materials, the shapes, and the relative positions of structural elements described in the present embodiment are examples. In addition, the order of processing operations is an example, and thus the order of processing operations can be changed or the processing operations can be performed in parallel within a scope not departing from the problems and the technical ideas of the present invention. Therefore, as long as limited descriptions are not particularly given, the technical scope of the present invention is not limited to the examples below.

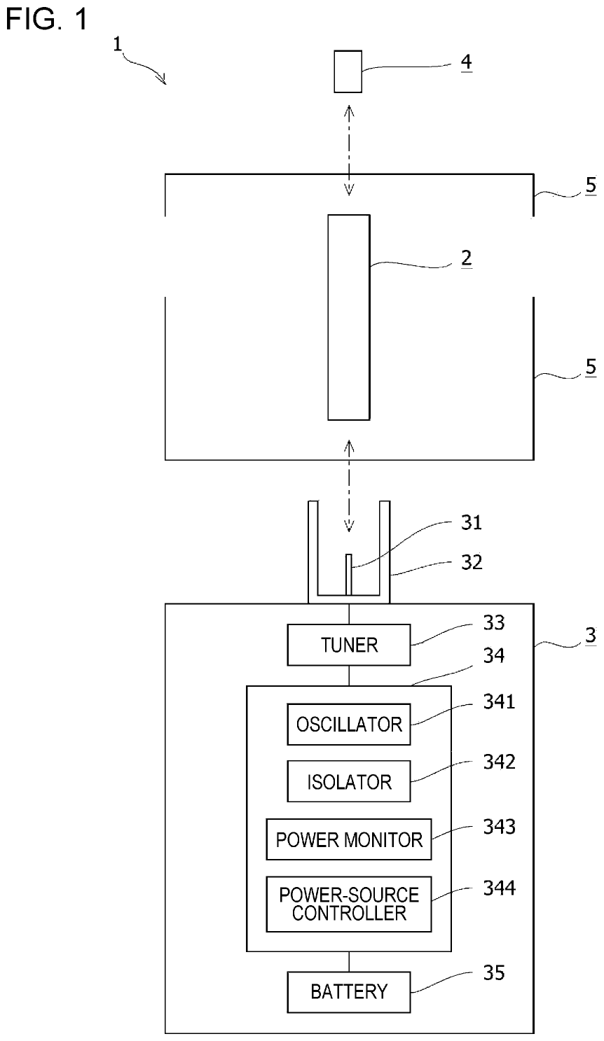

FIG. 1 is a schematic view of an example of a structure of the noncombustion-type flavor inhaler according to the present embodiment. A noncombustion-type flavor inhaler 1 according to the present embodiment includes a cartridge 2 that holds a liquid aerosol source, a body part 3 that includes an antenna 31 for heating the aerosol source by dielectric heating, a mouthpiece part 4, which is an inhalation port, for being held in the mouth of a user to inhale aerosols, and a case 5 that connects the cartridge 2, the body part 3, and the mouthpiece part 4. The body part 3 and the cartridge 2 are attachable/detachable to/from each other. The antenna 31 is, for example, a rod-shaped antenna. The cartridge 2 has, for example, a pillar shape, such as a circular pillar shape or a rectangular pillar shape, and allows the antenna 31 to be inserted/extracted into/from the cartridge 2 in an axial direction thereof. Note that, in the present embodiment, for convenience, a direction of insertion of the antenna 31, which is a direction in which the cartridge 2 and the mouthpiece part 4 are positioned in the noncombustion-type flavor inhaler 1, is defined as “up”, and a direction of extraction of the antenna 31, which is a direction in which the body part 3 is positioned in the noncombustion-type flavor inhaler 1, is defined as “down”.

<Body Part>

The body part 3 includes the antenna 31, a shield 32, a tuner 33, a microwave generating part 34, and a battery 35. The battery 35 is, for example, a rechargeable secondary battery, and supplies electric power to a circuit of the body part 3. The microwave generating part 34 is mounted on, for example, a circuit board, and includes an oscillator 341, an isolator 342, a power monitor 343, and a power-source controller 344. The oscillator 341 is, for example, a microwave oscillator of a semiconductor-type or a magnetron-type, and generates microwaves of a predetermined frequency. The isolator 342 absorbs microwaves reflected inside the body part 3, and controls backflow to the oscillator. The power monitor 343 measures reflected electric power and applied electric power to the microwave generating part 34. In accordance with, for example, inhalation (puffing) of a user, the power-source controller 344 controls electric power that is supplied to the microwave generating part 34. The tuner 33 is connected between the microwave generating part 34 and the antenna 31, and matches the impedance of the microwave generating part 34 and the impedance of a load to decrease reflected electric power. The antenna 31 is connected to the tuner 33 with, for example, a coaxial cable, and emits microwaves for heating the aerosol source to a location around the tuner 33. That is, for example, the rod-shaped antenna 31 emits microwaves outward in a radial direction thereof. An antenna length can be set as appropriate in accordance with the frequency of the microwaves that are emitted. That is, it is preferable that the antenna length be a value obtained by dividing a wavelength λ, determined based on the frequency, by a natural number (λ/n (n=1, 2, 3 . . . )). The antenna length may be, for example, 5 mm. An antenna diameter is, for example, 1 mm. The shield 32 is a metal wall part that is provided so as to be separated from the antenna 31 and cover the antenna 31. The shield 32 is connected to ground inside the circuit of the body part 3. The shield 32 absorbs or reflects microwaves that are emitted from the antenna 31, and suppresses leakage of the microwaves to the outside of the noncombustion-type flavor inhaler 1. Note that the shield 32 may be attachable/detachable to/from the body part 3.

Note that the body part 3 may include another structure. For example, when the body part 3 includes a pressure sensor and the pressure sensor detects a negative pressure generated by inhalation of a user, the power-source controller 344 above may control the operation of the microwave generating part 34. The body part 3 may include a display or an indicator, such as an LED, that indicates the state of operation of the body part 3 by being turned on or by flashing. The body part 3 may include a charging connector for being connected to a cable that supplies electric current for charging the battery 35, or a power receiver that is capable of receiving in a contactless manner electric power that is sent from an external power source. The body part 3 may include a controller that estimates a remaining amount of the aerosol source held by the cartridge 2 and performs control in accordance with the remaining amount.

<Mouthpiece Part>

The mouthpiece part 4 is an inhalation port through which a user inhales aerosols, and is connected to an end of an aerosol flow path of the cartridge 2. The mouthpiece part 4 may be, for example, a capsule filled with a flavor source of shredded tobacco or the like, and may be formed such that aerosols are added with flavor as a result of passage of the aerosols through an accommodating space of the flavor source. Note that the noncombustion-type flavor inhaler 1 may not include a mouthpiece part 4.

<Case>

The case 5 accommodates the cartridge 2 by, for example, two parts, and connects the cartridge 2 to the body part 3. The case 5 and the body part may each be provided with, for example, an externally threaded portion and an internally threaded portion, and may be screwed to each other. The mouthpiece part 4 is connected to an upper portion of the case 5. The upper portion of the case 5 and the mouthpiece part 4 may be connected by, for example, screwing an externally threaded portion and an internally threaded portion. Note that the upper portion of the case 5 may be integrated with the mouthpiece part 4. Note that a lower portion of the case 5 may be integrated with the body part 3. That is, the shield 32 of the body part 3 may constitute at least a part of the lower portion of the case 5. The mouthpiece part 4 may be connected to the shield 32 without including the upper portion of the case 5. Here, the shield 32 may cover the entire or substantially the entire cartridge 2. The mouthpiece part 4 may be connected to the cartridge 2 without including the upper portion of the case 5.

<Cartridge>

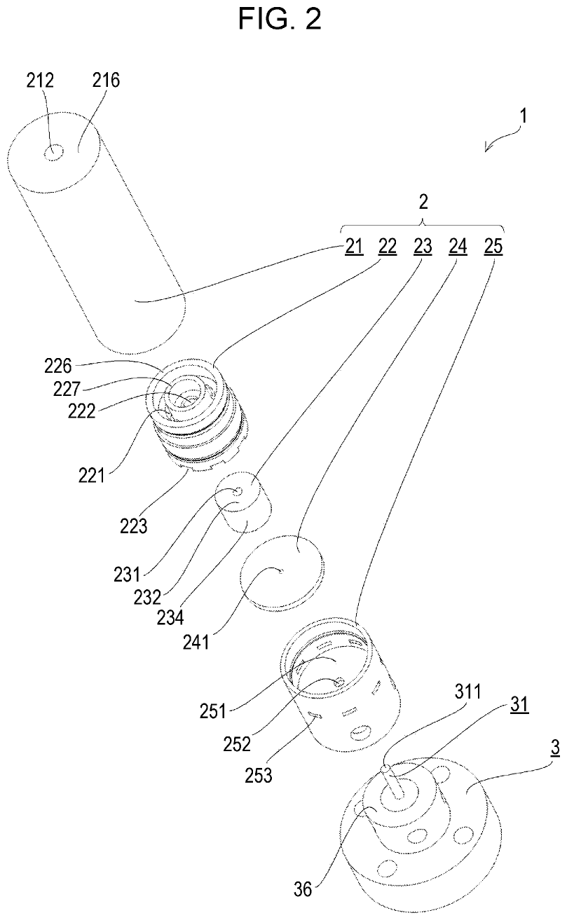

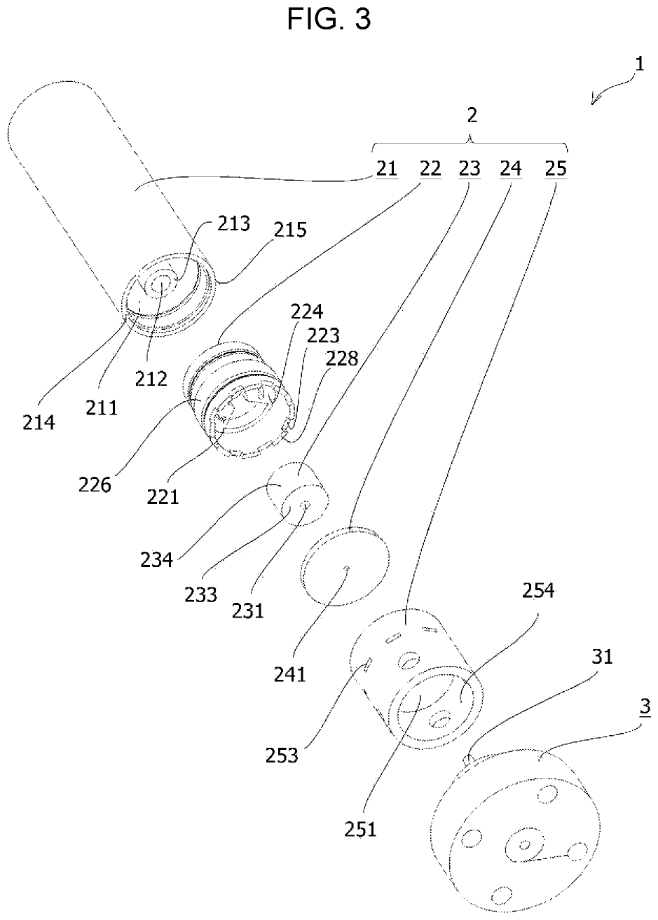

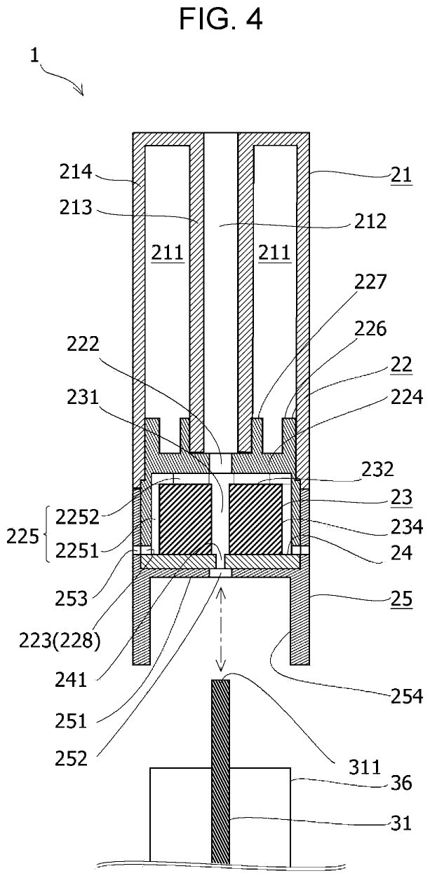

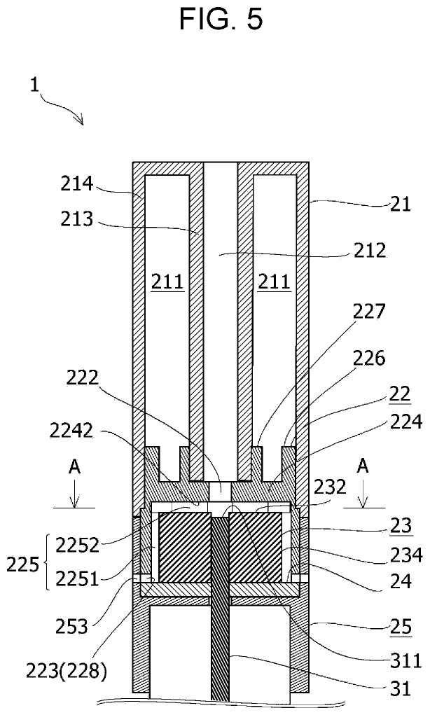

FIGS. 2 and 3 are each an exploded perspective view schematically showing a structure of a part of the body part and the cartridge. FIG. 4 is a longitudinal sectional view schematically showing a part of the body part and the cartridge in a detached state along a direction of insertion/extraction of the antenna. FIG. 5 is a longitudinal sectional view schematically showing a part of the body part and the cartridge in an attached state. The cartridge 2 includes a reservoir 21, a first reserving element accommodating member 22, a reserving element 23, a seal member 24, and a second reserving element accommodating member 25. Note that the shield 32 shown in FIG. 1 is not shown.

The reservoir 21 is a pillar-shaped member that extends along the direction of insertion/extraction of the antenna 31. The reservoir 21 includes a storage tank part 211 and an aerosol flow path 212. The storage tank part 211 has a double tubular structure in which a transverse section orthogonal to the direction of insertion/extraction (up-down direction) of the antenna 31 has a ring shape. That is, the reservoir 21 includes an inner tube 213 and an outer tube 214, and the storage tank part 211 is formed between the inner tube 213 and the outer tube 214.

The storage tank part 211 has an opening on a side of a lower end (first reservoir end part) 215 of the reservoir 21, and an upper portion of the first reserving element accommodating member 22 is inserted into the opening. The storage tank part 211 is closed on a side of an upper end (second reservoir end part) 216 of the reservoir 21. The storage tank part 211 is a space for storing the liquid aerosol source. The aerosol source is, for example, a liquid such as polyhydric alcohol such as glycerine or propylene glycol. Note that the aerosol source may be a liquid mixture further containing, for example, nicotine liquid, water, or a flavoring agent.

The aerosol flow path 212 is formed on an inner side of the inner tube 213 that is surrounded by the storage tank part 211 such that, in a transverse section, the aerosol flow path 212 is separated from the storage tank part 211 by the inner tube 213. The aerosol flow path 212 is a through hole that extends along the up-down direction, and the side of the lower end 215 of the reservoir 21 is in air communication with a space that accommodates the reserving element 23. The aerosol flow path 212 has the mouthpiece part 4 connected thereto on the side of the upper end 216 of the reservoir 21, and is in air communication with the mouthpiece part 4.

The reserving element 23 is a pillar-shaped member including an antenna accommodating part 231 that allows the antenna 31 to be inserted/extracted when the cartridge 2 is attached/detached to/from the body part 3. Although the reserving element 23 has, for example, a circular pillar shape, the reserving element may have a different pillar shape, such as an elliptical pillar shape or a rectangular pillar shape. The reserving element 23 has an upper surface (first reserving element end part) 232 that corresponds to an end part on the antenna insertion side, a bottom surface (second reserving element end part) 233 that corresponds to an end part on the antenna extraction side, and a side surface (side peripheral portion) 234. The antenna accommodating part 231 is, for example, a through hole that extends in an axial direction along a center of a transverse section of the reserving element 23. Note that the antenna accommodating part 231 may be a recessed part (that is, a non through hole) whose upper-surface-232 side is closed. It is preferable that the length of the antenna accommodating part 231 in the up-down direction be greater than or equal to the length of protrusion of the antenna 31. That is, in a state in which the antenna accommodating part 231 accommodates the antenna 31, due to a design in which an upper end 311 of the antenna 31 does not protrude beyond the upper surface 232 of the reserving element 23, the reserving element 23 is capable of sufficiently receiving microwaves that are emitted from the antenna 31. The length of the antenna accommodating part 231 in the up-down direction is determined in accordance with the antenna length, and is, for example, approximately 5 mm.

The reserving element 23 is made of, for example, a fiber material, such as glass fiber or rock wool, or a porous material, such as porous ceramic, and is capable of holding the aerosol source in the gaps. The reserving element 23 is disposed such that its upper surface 232 is in liquid communication with the storage tank part 211 of the reservoir 21, and absorbs the aerosol source by a capillary phenomenon.

The first reserving element accommodating member 22 is a circular cylindrical member that is connected to a lower-end side of the reservoir 21. A disk-shaped partition wall 224 is provided on an inner side of a wall part 226, which is a side wall of the first reserving element accommodating member 22, and divides an internal space of the first reserving element accommodating member 22 into an upper portion and a lower portion. Concentric wall parts 226 and 227 protrude at the upper portion of the first reserving element accommodating member 22. The outside diameter of the wall part 226, which is an outer-peripheral-side side wall, corresponds to the inside diameter of the outer tube 214 of the reservoir 21. The inside diameter of the inner-peripheral-side wall part 227 corresponds to the outside diameter of the inner tube 213 of the reservoir 21. The wall parts 226 and 227 are inserted into the storage tank part 211, and the first reserving element accommodating member 22 is connected to a lower end of the storage tank part 211. Note that the wall part 226 also extends below the partition wall 224.

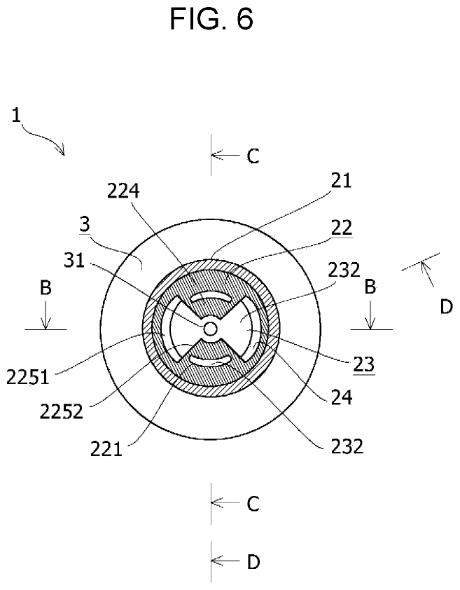

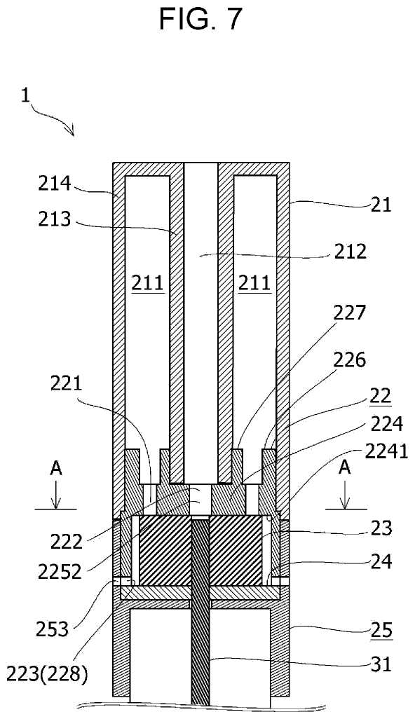

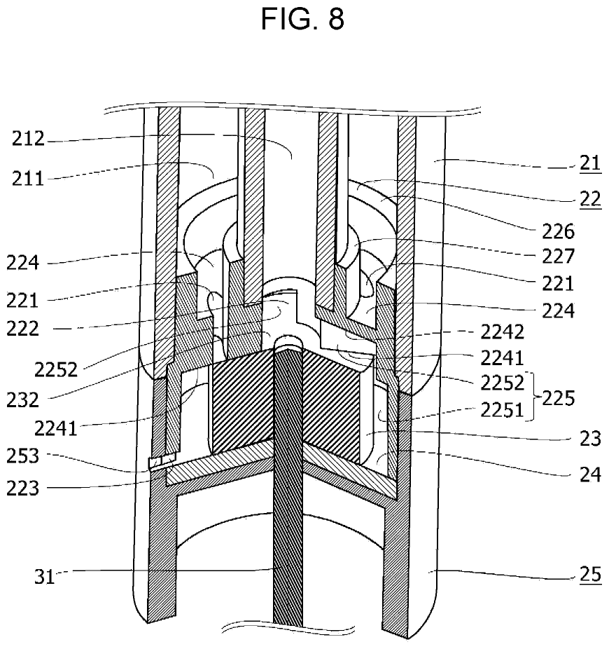

The first reserving element accommodating member 22 forms a space that accommodates the reserving element 23 in a lower portion of the partition wall 224. That is, the first reserving element accommodating member 22 forms a space that accommodates the reserving element 23 in a region that is separated from the storage tank part 211 by the partition wall 224. FIG. 6 is a sectional view of a part of the body part and the cartridge along a cutting-plane line A-A in FIG. 5. That is, FIG. 6 shows a transverse section of the noncombustion-type flavor inhaler 1 in a radial direction. Note that FIG. 5 corresponds to a sectional view of a part of the body part and the cartridge along a cutting-plane line B-B in FIG. 6. FIG. 7 is a sectional view of a part of the body part and the cartridge along a cutting-plane line C-C in FIG. 6. Section C-C is also a longitudinal section along an axial direction of the cartridge 2. However, the section C-C differs from the section B-B above in that a cutting plane orientation differs by 90 degrees, and in that the C-C section passes through the inside of first through holes 221 provided in the partition wall 224. FIG. 8 is a perspective sectional view of a part of the body part and the cartridge along a cutting-plane line D-D in FIG. 6.

Each first through hole 221 is an aerosol source supply path that extends through the partition wall 224 and that causes the reserving element 23 and the storage tank part 211 of the reservoir 21 to be in liquid communication. In other words, the reservoir 21 is in liquid communication with the upper surface 232 of the reserving element 23 through each first through hole 221 of the partition wall 224. Each first through hole 221 is an arc-shaped long hole provided along the storage tank part 211 whose section is circular. As shown in, for example, FIG. 6, two first through holes 221 are provided in the partition wall 224. A second through hole 222 that passes through the center of the partition wall 224 is also provided in the partition wall 224. The second through hole 222 causes the space that accommodates the reserving element 23 and the aerosol flow path 212 of the reservoir 21 to be in air communication.

As shown in FIGS. 5 to 8, a step is provided at the lower portion of the partition 224. That is, as shown in, for example, FIG. 8, of the partition wall 224, a portion surrounding each first through hole 221 and other portions are formed such that the thickness of the partition wall 224 varies. A lower step portion 2241 that extends such that the lower portion of the partition wall 224 contacts the upper surface of the reserving element 23 is formed around each first through hole 221. Therefore, each first through hole 221 causes the storage tank part 211 of the reservoir 21 and the upper surface of the reserving element 23 to be in liquid communication. An upper step portion 2242 is formed so as to be separated from the upper surface of the reserving element 23 such that, of the partition wall 224, a portion other than the portion around each first through hole 221 is provided with a gap between the lower portion of the partition wall 224 and the upper surface 232 of the reserving element 23.

As shown in, for example, FIGS. 5 and 8, a chamber 225 is formed around the reserving element 23 in the space that accommodates the reserving element 23. The chamber 225 includes a first chamber region 2251 that is formed to face the side peripheral portion 234 of the reserving element 23 and a second chamber region 2252 that is formed above the upper surface 232 of the reserving element 23. The first chamber region 2251 and the second chamber region 2252 are a continuous space. The first chamber region 2251 is provided at at least a part of an outer side of the side peripheral portion of the reserving element 23. The first chamber region 2251 may be provided on an outer side of the reserving element 23 over the entire periphery of the side peripheral portion of the reserving element 23. The second chamber region 2252 is a gap between the reserving element 23 and the upper step portion 2242 of the partition wall 224. The second through hole 222 above causes the second chamber region 2252 and the aerosol flow path 212 of the reservoir 21 to be in air communication. Note that the chamber 225 that is formed around the reserving element 23 may include only the first chamber region 2251 or only the second chamber region 2252.

At the wall part 226, which is a side wall of the first reserving element accommodating member 22, air intakes 223, which are intakes of air, are provided in an end part region 228 that is positioned on a lower side of the wall part 226. Note that the air intakes 223 are provided along a peripheral direction of the first reserving element accommodating member 22. Therefore, in the chamber 225, when air that has been taken in from the outside circulates, the air and aerosols generated by microwaves emitted from the antenna 31 are mixed with each other. In general, generated aerosols may re-coagulate. In the present embodiment, when the first chamber region 2251 and the second chamber region 2252 are provided around the reserving element 23, it is possible to expose the surface of the reserving element 23 in a wide manner to the chamber 225 to the extent possible. This makes it possible to emit more aerosols from an exposed surface of the reserving element 23 and to increase the efficiency of generating aerosols by suppressing re-coagulation of the aerosols. Note that, for example, even if only the first chamber region 2251 or only the second chamber region 2252 is provided, it is possible to increase the area of exposure of the reserving element 23 to the chamber 225 and to increase the efficiency of generating aerosols.

The seal member 24 is a disk-shaped member having a through hole 241 in its center, and is disposed between the reserving element 23 and the second reserving element accommodating member 25. The reserving element 23 inside the first reserving element accommodating member 22 and the second reserving element accommodating member 25 may be positioned by being interposed between the partition wall 224 and the seal member 24 or by using connecting means, such as an adhesive.

The seal member 24 is made of an elastic material, such as silicon, and the antenna 31 is insertable/extractable into/from the through hole 241. For example, the through hole 241 is brought into a substantially closed state before the insertion of the antenna 31 to suppress leakage of the aerosol source. When the antenna 31 is inserted, the diameter of the through hole 241 is increased due to the passage of the antenna 31. When the antenna 31 is extracted, the through hole 241 functions as a scraper that wipes off the aerosol source adhered to the antenna 31.

The second reserving element accommodating member 25 is a cylindrical member and includes a holding wall 251 in the interior thereof. The holding wall 251 is disposed to face the partition wall 224 of the first reserving element accommodating member 22, and holds the reserving element 23 between the holding wall 251 and the partition wall 224. The holding wall 251 has a through hole 252 in its center thereof, the diameter of the through hole 252 being larger than the diameter of the antenna 31. Of the second reserving element accommodating member 25, the holding wall 251 and its upper portion form a space that holds, together with the first reserving element accommodating member 22, the reserving element 23. Air intakes 253 are provided in, of positions on a side surface of the second reserving element accommodating member 25, positions that correspond to the positions of the air intakes 223 provided in a side surface of the first reserving element accommodating member 22. In a state in which the cartridge 2 is assembled, each air intake 223 and a corresponding one of the air intakes 253 form one through hole in a side surface of the chamber 225. In accordance with inhalation of a user, outside air is introduced from the air intakes 223 and the air intakes 253. As described above, the chamber 225 is capable of taking in air from a surrounding region of a lower end of the chamber 225, and is capable of discharging aerosols from the center of an upper portion of the chamber 225. Since a flow in one direction occurs in the chamber 225, it is possible to suppress occurrence of stagnation or turbulence inside the chamber 225, and to suppress re-coagulation of aerosols occurring due to the stagnation or the turbulence.

Of the second reserving element accommodating member 25, the holding wall 251 and its lower portion are attachable/detachable to/from the body part 3. The second reserving element accommodating member 25 includes, for example, an engaging part 254 that engages with an engage part 36 of the body part 3. The engage part 36 and the engaging part 254 may have, for example, a concave form and a convex form that are insertably/extractably fitted, and may have a structure that allows the case 5 that accommodates the cartridge 2 to be attached to the body part 3. Note that the engage part 36 and the engaging part 254 may include an externally threaded portion and an internally threaded portion that are screwed to each other. A boundary between the engage part 36 and the engaging part 254 is substantially parallel to an extension direction of the antenna 31, and the engage part 36 and the engaging part 254 guide the antenna 31 in the direction of insertion thereof when the cartridge 2 is attached/detached to/from the body part 3. In particular, when the length of protrusion of the engage part 36 or the depth of the engaging part 254 is larger than the length of protrusion of the antenna 31, it is possible to straightly insert the antenna 31 into the antenna accommodating part 231 when the cartridge 2 is attached/detached to/from the body part 3.

In the assembled cartridge 2, a part of the aerosol source that is stored in the storage tank part 211 of the reservoir 21 is absorbed by the reserving element 23. When the noncombustion-type flavor inhaler 1 is used, the aerosol source absorbed by the reserving element 23 is heated and vaporized or atomized by microwaves emitted by the antenna 31. Aerosols generated inside the chamber 225 of the first reserving element accommodating member 22 pass through the aerosol flow path 212 of the reservoir 21 and are inhaled by a user.

### Effects

If, for example, the storage tank part 211 is disposed around the antenna 31 in a radial direction, microwaves that are emitted by the antenna 31 are absorbed by the aerosol source that is stored in the storage tank part 211, and energy loss occurs. Due to the remaining amount of the aerosol source or the existence of the aerosol source toward a certain side inside the storage tank part 211, dielectric heating may become ununiform. In the embodiment above, the reservoir 21, the reserving element 23, and the antenna 31 are disposed in series along the up-down direction. That is, the lower end of the storage tank part 211 of the reservoir 21 is disposed above the upper end of the antenna 31 inserted into the antenna accommodating part 231. Therefore, microwaves that are primarily emitted outward of the antenna 31 in a radial direction are hardly absorbed by the aerosol source that is held by the storage tank part 211. Therefore, according to the noncombustion-type flavor inhaler 1 above, it is possible to reduce energy loss.

The reservoir 21 is in liquid communication with an upper end part of the reserving element 23. This facilitates designing for disposing the reservoir 21 above the reserving element 23. In general, a user holds the noncombustion-type flavor inhaler 1 in the mouth substantially horizontally and inhales aerosols, or tilts an end of the noncombustion-type flavor inhaler 1 downward in a vertical direction and inhales aerosols. This means that, between inhalations, the cartridge 2 is held on an upper side in the vertical direction and the body part 3 is held on a lower side in the vertical direction. When the reservoir 21 is caused to be in liquid communication with the upper end part of the reserving element 23, since, between inhalations, the aerosol source moves in a gravitational direction toward the reserving element 23 from the storage tank part 211 of the reservoir 21, the aerosol source is stably supplied to the reserving element 23 from the storage tank part 211. Even if the sectional area of through holes where the reserving element 23 and the reservoir 21 are in liquid communication is made relatively small, the aerosol source is sufficiently supplied. By decreasing the cross section of a portion where the reserving element 23 and the reservoir 21 are connected, even from the point of making it possible to suppress heat transfer from the reserving element 23 to the reservoir 21, it is possible to reduce energy loss.

Note that the cartridge 2 above can be manufactured without using a metal. Therefore, manufacturing costs of the cartridge 2 can be reduced and the cartridge 2 is easily recycled.

<Modification of Reserving Element>

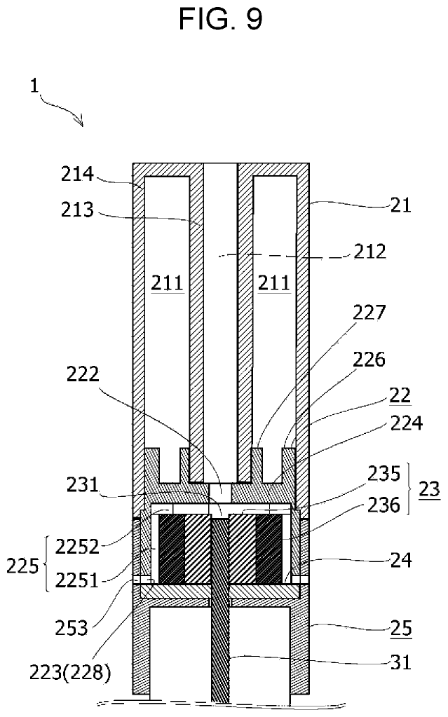

FIG. 9 illustrates a modification of a reserving element. Note that structures that are the same as those of the embodiment above are given the same reference numerals and are not described below. A reserving element 23 shown in FIG. 9 includes a plurality of layers having different capillary forces. Specifically, the reserving element 23 includes a first portion 235 that constitutes a part of the reserving element 23, and a second portion 236 that has a capillary force that is larger than the capillary force of the first portion 235. Portions whose capillary forces differ relative to each other can be formed by, for example, causing air permeabilities to differ from each other. When a pressure difference between the pressures on the front and rear sides with the reserving element interposed therebetween is, for example, a predetermined value, such as 1 kPa, the air permeability is expressed by the flow rate [ml] of a gas that passes a unit area (1 cm²) in one minute. For example, the portion having a small capillary force preferably has an air permeability of 10,000 [ml/min/cm²] or greater, and the portion having a large capillary force preferably has an air permeability of less than 10,000 [ml/min/cm²]. The first portion 235 and the second portion 236 may be made of the same material or may be made of different materials. For example, the first portion 235 may be made of a fibrous material, and the second portion 236 may be made of a porous ceramic. In particular, it is preferable that the first portion 235 that may contact the antenna 31 be made of a fibrous material because the antenna in such a case is not scratched.

As shown in FIG. 9, the first portion 235 may be formed on an inner side of the reserving element 23 in a radial direction and the second portion 236 may be formed on the outer side of the reserving element 23 in the radial direction. In the example of FIG. 9, the reserving element 23 includes two layers with a double concentric form in transverse sectional view (not shown). That is, from the inner side toward the outer side in the section, the antenna accommodating part 231, the first portion 235, and the second portion 236 are positioned. In other words, the first portion 235 and the second portion 236 are disposed in parallel with respect to a direction of extension of the antenna accommodating part 231. The second portion 236 is in liquid communication with the storage tank part 211 of the reservoir 21. Therefore, the aerosol source is supplied to the second portion 236.

According to the example of FIG. 9, the aerosol source is primarily held by the second portion 236 having a large capillary force. Here, when performing heating by using microwaves, it is better for the quantity of the aerosol source that is held by the reserving element 23 to be small from the viewpoint of vaporizing or atomizing the aerosol source with a small amount of energy. Note that, in order to vaporize or atomize the aerosol source with a small amount of energy, the reserving element 23, such as the second portion 236, may be made thin. Since the second portion has a relatively large capillary force, when the aerosol source that is being held is vaporized or atomized and is discharged to the chamber 255, the aerosol source can be relatively quickly absorbed. By providing the second portion 236 having a low air permeability on the outer side of the reserving element 23 in the radial direction, it is possible to efficiently discharge aerosols from a side peripheral surface of the reserving element 23 facing the chamber 225.

On the other hand, the first portion 235 functions as a sub-reservoir that absorbs the aerosol source that cannot be completely held by the second portion 236. For example, in the cartridge 2 being used, the aerosol source and air exist in the storage tank part 211 of the reservoir 21. When the cartridge 2 is stored with the inhalation port side being oriented upward in a vertical direction, the aerosol source moves to a lower side in the storage tank part 211 and the air is held on an upper side of the storage tank part 211. When, in this state, the internal pressure of the storage tank part 211 is changed due to a change in temperature or atmospheric pressure, for example, the air on the inner side may expand to generate a force that pushes out the aerosol source. Even if the aerosol source is pushed out from the storage tank part 211, when the first portion 235 is capable of further absorbing the aerosol source, it is possible to prevent leakage of the aerosol source from the cartridge 2.

Note that it is preferable for the outside diameter of the second portion 236 to be approximately 3 to 8 mm. In addition, it is preferable that the outside diameter of the first portion 235 be approximately 5 mm from the viewpoint of functioning as a sub-reservoir.

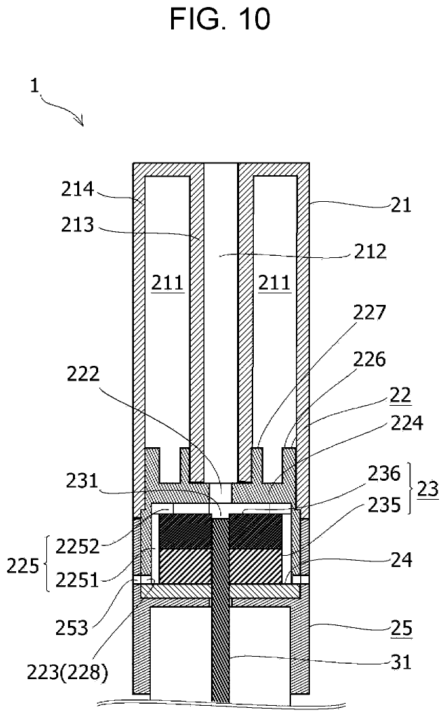

FIG. 10 illustrates another modification of a reserving element. A reserving element 23 shown in FIG. 10 also includes a plurality of layers having different capillary forces. In the example of FIG. 10, a first portion 235 is formed at a lower portion of the reserving element 23, and a second portion 236 having a capillary force that is larger than the capillary force of the first portion 235 is formed at an upper portion of the reserving element 23. That is, the first portion 235 and the second portion 236 are disposed in series in an extension direction of the antenna accommodating part 231. In addition, the second portion 236 is in liquid communication with the storage tank part 211 of the reservoir 21. Therefore, an aerosol source is supplied to the second portion 236. Note that, in the present embodiment, at least the second portion 236 needs to be exposed to the second chamber region 2252. That is, a side periphery of the first portion 235 may be covered by the first reserving element accommodating member 22 or the second reserving element accommodating member 25.

Even in the example of FIG. 10, the aerosol source is primarily held by the second portion 236 having a large capillary force. By providing the second portion 236 at the upper portion of the reserving element 23, it is possible to efficiently generate aerosols at a side peripheral upper portion of the reserving element 23 and the upper surface of the reserving element 23.

Even in the example of FIG. 10, the first portion 235 functions as a sub-reservoir that absorbs the aerosol source that cannot be completely held by the second portion. That is, even if the aerosol source leaks from the storage tank part 211, when the first portion 235 above is capable of further absorbing the aerosol source, it is possible to prevent leakage of the aerosol source from the cartridge 2.

The first portion 235 and the second portion 236 may be at least partly disposed in parallel or in series, with respect to a direction of insertion/extraction of the antenna. For example, the second portion 236 may be provided along, of the reserving element 23, the upper surface 232 and the side surface 234 exposed to the chamber 225. A boundary between the first portion 235 and the second portion 236 may be obliquely provided with respect to a direction of extension of the antenna accommodating part 231 in longitudinal sectional view shown in FIGS. 9 and 10. The relationship between the magnitudes of the capillary forces of the first portion 235 and the second portion 236, shown in FIGS. 9 and 10, may be reversed. For example, in accordance with, for example, the range of emission of microwaves from the antenna, it is possible to set the relationship between the magnitudes of the capillary forces as appropriate. The reserving element 23 shown in FIGS. 9 and 10 may include three or more layers having different capillary forces.

<Antenna Cover>

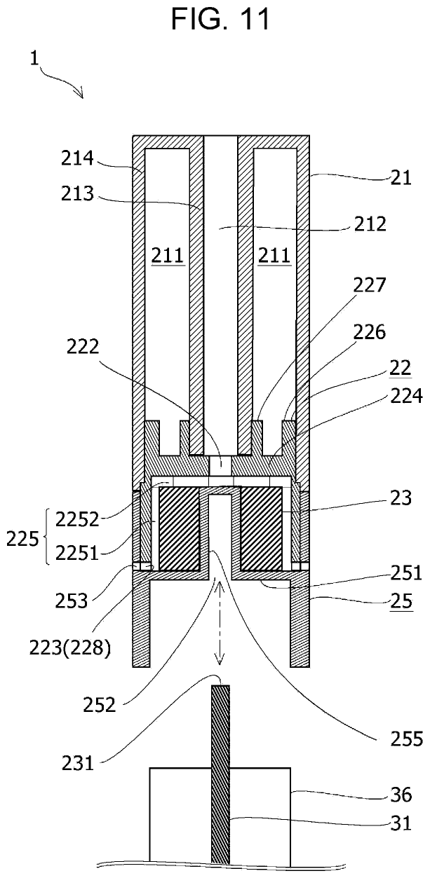

FIG. 11 illustrates an example of a cartridge including an antenna cover. A holding wall 251 of a second reserving element accommodating member 25 shown in FIG. 11 is such that an upper side of a hole 252 is closed by a cylindrical antenna cover 255 having a bottom. The antenna cover 255 is a cover member that is provided between a reserving element 23 and an antenna accommodating part 231 provided in the inside thereof, and that is provided for accommodating an antenna 31. Note that the antenna cover 255 may be integrated with the second reserving element accommodating member 25, or may be a separate member that is connected to the second reserving element accommodating member 25. The antenna cover 255 protrudes upward from the hole 252 of the holding wall 251, and has an internal portion that is a hollow antenna insertion hole. The antenna 31 can be inserted into the antenna cover 255 from the hole 252.

The reserving element 23 is disposed on an outer portion of the antenna cover 255. In other words, the antenna cover 255 is inserted into the antenna accommodating part 231 of the reserving element 23 of the embodiment above. The cartridge 2 does not include a seal member 24 of the embodiment above. Therefore, in the present modification, the holding wall 251 is disposed to face a partition wall 224 of a first reserving element accommodating member 22, and the reserving element 23 is held between the holding wall 251 and the partition wall 224.

It is preferable that the material of the antenna cover 255 be, for example, polycarbonate, Tritan (registered tradename), or glass. The antenna cover 255 is non-transmissive with respect to a liquid aerosol source, and is transmissive with respect to microwaves. It is preferable that the thickness of the antenna cover 255 be 0.5 mm to 1.0 mm. It is preferable that a gap between the antenna 31 and the antenna cover 255 be small. This makes it possible to reduce absorption of microwaves by the antenna cover 255. It is preferable that the antenna cover 255 be heat-resistant with respect to a predetermined temperature. It is preferable that the predetermined temperature be greater than or equal to a vaporization temperature of the aerosol source, such as 300° C.

Even when the noncombustion-type flavor inhaler 1 includes the antenna cover 255, the noncombustion-type flavor inhaler 1 is capable of performing dielectric heating on an aerosol source by using microwaves. According to the antenna cover 255, it is possible to prevent the aerosol source from directly adhering to the antenna 31. Therefore, it is possible to suppress, for example, deterioration in the performance of the antenna 31 and corrosion of the antenna 31. It is also possible to suppress leakage of the aerosol source to the antenna accommodating part 231 from the reserving element 23. In particular, when the cartridge 2 is provided with a cover, it is possible to prevent stickiness of the body part 3 after removing the cartridge 2 and to prevent mixture of inhaling flavors when a cartridge 2 holding different aerosol sources is used.

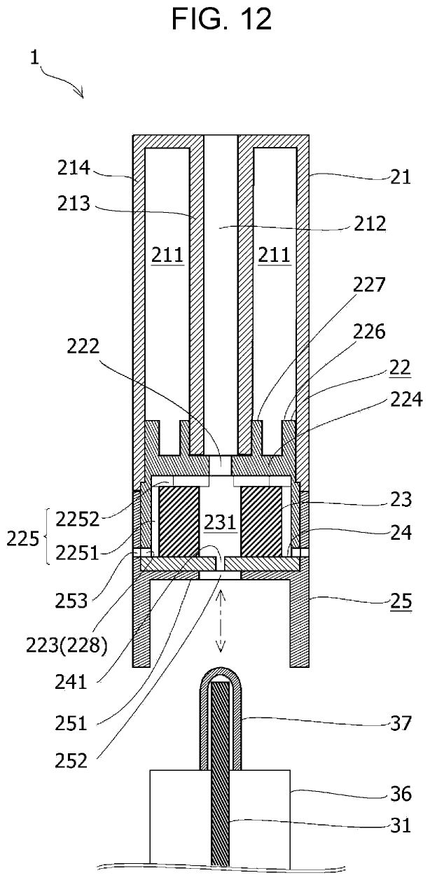

FIG. 12 illustrates an example in which the body part is provided with an antenna cover. The body part 3 includes an antenna cover 37 so as to cover the antenna 31. It is preferable that the material of the antenna cover 37 also be, for example, polycarbonate or Tritan. It is preferable that the thickness of the antenna cover 37 be 0.5 mm to 1.0 mm. It is preferable that a gap between the antenna 31 and the antenna cover 37 be small. It is preferable that the antenna cover 37 be heat-resistant with respect to a predetermined temperature. It is preferable that the predetermined temperature be greater than or equal to a vaporization temperature of an aerosol source, such as 300° C.

Note that, in the example of FIG. 12, the diameter of the through hole 252 of the holding wall 251 of the second reserving element accommodating member 25 and the diameter of the antenna accommodating part 231 of the reserving element 23 are greater than or equal to the diameter of the antenna cover 37. The through hole 241 of the seal member 24 is also capable of receiving the antenna cover 37.

Even when the noncombustion-type flavor inhaler 1 includes the antenna cover 37, the noncombustion-type flavor inhaler 1 is capable of performing dielectric heating on an aerosol source by using microwaves. According to the antenna cover 37, it is possible to prevent the aerosol source from directly adhering to the antenna 31. Therefore, it is possible to suppress, for example, deterioration in the performance of the antenna 31 and corrosion of the antenna 31.

<Others>

The structures described in the embodiment and the modifications above can be combined to the extent possible within a scope not departing from the problems and the technical ideas of the present invention. For example, the reserving element shown in FIG. 9 or FIG. 10 and the antenna cover shown in FIG. 11 or FIG. 12 may be combined. The cartridge including the reserving element shown in FIG. 9 or FIG. 10 or the noncombustion-type flavor inhaler including the antenna cover shown in FIG. 11 or FIG. 12 need not be those in which the reservoir and the reserving element are disposed in series in the up-down direction, or need not be those in which a chamber is provided around the reserving element.

### REFERENCE SIGNS LIST

1 noncombustion-type flavor inhaler
2 cartridge
21 reservoir
211 storage tank part
212 aerosol flow path
22 first reserving element accommodating member
221 first through hole (aerosol source supply path)
222 second through hole
223 air intake
224 partition wall
225 chamber (2251: first chamber region, 2252: second chamber region)
23 reserving element (235: first portion, 236: second portion)
231 antenna accommodating part
24 seal member
25 second reserving element accommodating member
251 holding wall
252 hole (through hole)
253 air intake
254 engaging part
255 antenna cover (cover member)
3 body part
31 antenna
32 shield
36 engage part
37 antenna cover (cover member)
4 mouthpiece part
5 case

1. A cartridge that is attachable/detachable to/from a body part of a noncombustion-type flavor inhaler including an antenna that emits microwaves for heating an aerosol source, the cartridge comprising:
a reserving element that is capable of holding the aerosol source and that has an antenna accommodating part that is capable of insertably/extractably accommodating the antenna when attaching/detaching the cartridge to/from the body part; and
a reservoir that stores the aerosol source for being supplied to the reserving element and that is in liquid communication with a first reserving element end part that is located on an antenna insertion side of the reserving element, the antenna insertion side of the reserving element being a side toward which the antenna is inserted.

2. The cartridge according to claim 1,
wherein the reservoir extends along a direction of insertion/extraction of the antenna into/from the antenna accommodating part.

3. The cartridge according to claim 1,
wherein the reservoir is disposed in series with the reserving element along a direction of insertion of the antenna into the antenna accommodating part.

4. The cartridge according to claim 1,
wherein, of the reservoir, a first reservoir end part that is located on a side toward which the antenna is extracted from the antenna accommodating part is disposed closer to an antenna insertion side than an insertion end of the antenna in an inserted state with respect to the antenna accommodating part.

5. The cartridge according to claim 1, further comprising:
a reserving element accommodating member that accommodates the reserving element such that a chamber is formed around the reserving element, the chamber being provided to allow air taken in from outside to circulate therein and being provided for mixing the air and the aerosol source vaporized or atomized by microwaves emitted from the antenna.

6. The cartridge according to claim 5,
wherein the reserving element has a pillar shape, and
wherein the chamber includes a first chamber region that faces a side peripheral portion of the reserving element and a second chamber region that faces the first reserving element end part that is located on the antenna insertion side of the reserving element.

7. The cartridge according to claim 5,
wherein the reserving element accommodating member includes a partition wall that serves as a partition between the reservoir and the first reserving element end part, and
wherein an aerosol source supply path for supplying the aerosol source stored in the reservoir to the first reserving element end part is formed in the partition wall.

8. The cartridge according to claim 7,
wherein the reservoir includes
a storage tank part that has a double tubular structure in which a transverse section orthogonal to a direction of insertion/extraction of the antenna has a ring shape, and
an aerosol flow path that is formed on an inner side of an inner tube of the storage tank part so as to be separated from the storage tank part by the inner tube, and that is in air communication with an inhalation port of the noncombustion-type flavor inhaler, and
wherein an air-flow path for circulating aerosol in the aerosol flow path is formed in the partition wall, the aerosol being generated in the chamber.

9. The cartridge according to claim 7,
wherein the reserving element accommodating member includes a holding wall that is disposed to face the partition wall, and
wherein the reserving element is held between the partition wall and the holding wall.

10. A noncombustion-type flavor inhaler comprising:
the cartridge according to claim 1;
the body part to which/from which the cartridge is attachable/detachable; and
the antenna.
